(19) United States
(12) Patent Application Publication
(10) Pub. No.: US 2006/0003301 A1
(43) Pub. Date: Jan. 5, 2006

(54) Device for simulation of a human figure

(76) Inventor: Joseph P. Biggins, Santa Monica, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,942

(22) Filed: Jun. 30, 2004

(51) Int. Cl. E05C 19/18

(52) U.S. Cl. 434/267

(57) ABSTRACT

A device for simulation of a human figure is described. In one embodiment, the device includes a torso portion including at least one anchor member affixed to the surface of the torso portion. A head portion is also coupled to the torso portion. In one embodiment, the head portion includes at least one anchor member affixed to a surface of the head portion and adapted to couple to the anchor member of the torso portion to simulate posture of the human figure. In one embodiment, a base portion may be coupled to the torso portion distal from the head portion. In one embodiment, this base portion is adapted to maintain the device in an upright position. Other embodiments are described and claimed.

### FIELD OF THE INVENTION

The present invention relates generally to the field of crown scene simulation. More particularly, in one embodiment, the device relates to a device for simulation of a human figure.

### BACKGROUND OF THE INVENTION

The motion picture and television industries frequently film scenes that are observed by a crowd of bystanders. For example, a scene filmed inside a stadium, such as a football stadium, is often focused on the field of play and generally include a crowd within the background. In the past, the filming of such crowd scenes has involved the hiring of motion picture extras, which are paid a per diem fee, as well as being supplied with food and drinks during filming.

Unfortunately, many of the scenes involving movie extras do not occur until the main scenes involving the main actors of the scene are filmed. As a result, movie extras generally spend a substantial amount of time waiting on the set for the filming of their scene. Yet, as the crowd scenes become larger, the need for motion picture extras also increases. The cost associated with the employment of potentially thousands of motion picture extras to fill a stadium to provide a crowd scene for the event that is occurring within the field of play is unduly costly.

As a cost-saving measure, cardboard cut-outs are frequently used within the stands of a sports stadium to simulate a crowd scene. Unfortunately, due to the two-dimensional characteristics of cardboard cut-outs, such cardboard cut-out crowd scenes can only be filmed from a certain angle; and therefore, often limit the authenticity of the crowd scene. Another potential solution to capture crowd scenes for a television or motion picture is the use of computer-generated imagery (CGI). Unfortunately, the costs associated with CGI for crowd scene simulation are quite costly; often exceeding the amounts required to employ the thousands of extras required to provide the spectators of a sporting event.

A device for simulation of a human figure is described. In one embodiment, the device includes a torso portion including at least one anchor member affixed to the surface of the torso portion. A head portion is also coupled to the torso portion. In one embodiment, the head portion includes at least one anchor member affixed to a surface of the head portion and adapted to couple to the anchor member of the torso portion to simulate posture of the human figure. In one embodiment, a base portion may be coupled to the torso portion distal from the head portion. In one embodiment, this base portion is adapted to maintain the device in an upright position.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a front view of a device for simulation of a human figure, in accordance with one embodiment.

FIG. 2 is a block diagram illustrating a rear view of a device for simulation of a human figure, in accordance with one embodiment.

FIG. 3A is a block diagram illustrating a base portion of the device illustrated in FIGS. 1 and 2, in accordance with one embodiment.

FIG. 3B is a block diagram illustrating a chip including a mounting pin to mate with a mounting receptacle of the base of FIG. 3A, in accordance with one embodiment.

FIG. 4 is a block diagram illustrating a right-side view of a device for simulation of a human figure, including a removable mask to simulate a face of the human figure, in accordance with one embodiment.

FIG. 5 is a block diagram further illustrating the device of FIG. 4 having adjoined anchors to simulate posture of a human figure, in accordance with one embodiment.

FIG. 6 is a block is a block diagram illustrating a right-side view of a device for simulation of a human figure, in accordance with one embodiment.

FIG. 7 is a block diagram illustrating a left-side view of a device for simulation of a human figure, in accordance with one embodiment.

FIG. 8 is a block diagram further illustrating opposed shoulder portions of FIGS. 6 and 7 to secure straps to the device, in accordance with one embodiment.

FIG. 9 is a block diagram further illustrating the strap of FIG. 7, in accordance with one embodiment.

FIG. 10 is a block diagram further illustrating the strap of FIG. 6, in accordance with one embodiment.

FIG. 11 is a block diagram further illustrating the rear-side view of the device of FIG. 1 having a removable mask secured to the head portion proximate the anchor members to enable simulation of a relaxed posture, in accordance with one embodiment.

FIG. 12 is a block diagram further illustrating a plurality of devices for simulation of a human figure, as illustrated with reference to FIGS. 4-7, joined together to simulate a crowd scene, in accordance with one embodiment.

### DETAILED DESCRIPTION OF THE INVENTION

A device for simulation of a human figure is described. In the following description, for the purposes of explanation, numerous specific details are set forth to provide a thorough understanding of the present invention. It will be apparent, however, to one skilled in the art that the present invention may be practiced without some of these specific details. In addition, the following description provides examples, and the accompanying drawings show various examples for the purposes of illustration. However, these examples should not be construed in a limiting sense as they are merely intended to provide examples of the present invention rather than to provide an exhaustive list of all possible implementations of the present invention. In other instances, well-known structures and devices are shown in block diagram form to avoid obscuring the details of the present invention.

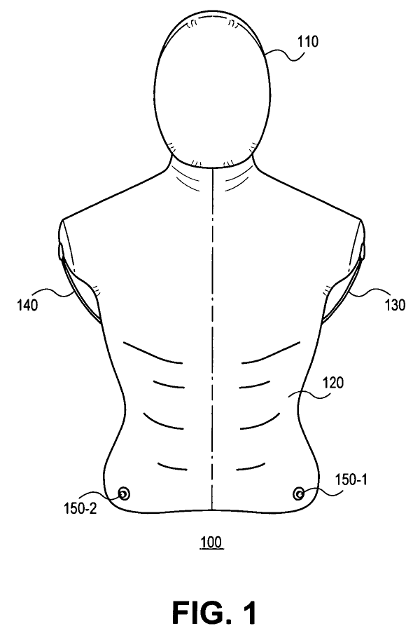

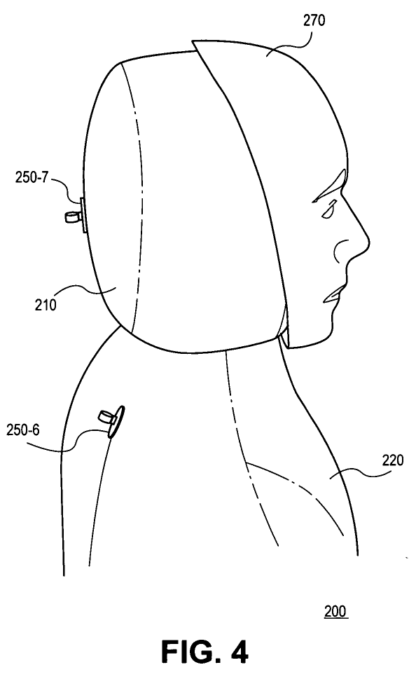

FIG. 1 is a block diagram illustrating a front view of device 100 for simulation of a human figure, in accordance with one embodiment. References to front and rear are for convenience only and when dressed, either side of device 100 may be defined as “front” or “rear.” Representatively, device 100 includes torso portion 120 coupled to head portion 110. In one embodiment, a removable mask (see FIGS. 4-7) is secured to head portion 110 to further simulate a face of a human figure. As further illustrated in FIG. 1, strap 130 and strap 140 may be coupled to torso portion 120. In one embodiment, straps 130 and strap 140 secure device 100 according to a desired position, such as an upright position to stabilize device 100.

In one embodiment, torso portion 120 comprises at least one panel of flexible material defining a first chamber that is filled with a fluid to define torso portion 120. In one embodiment, head portion 110 comprises at least one panel of flexible material defining a second chamber that is filled with the fluid to define head portion 110. Representatively, head portion 110 is coupled to torso portion 120. In one embodiment, head portion 110 and torso portion 120 are in fluid communication.

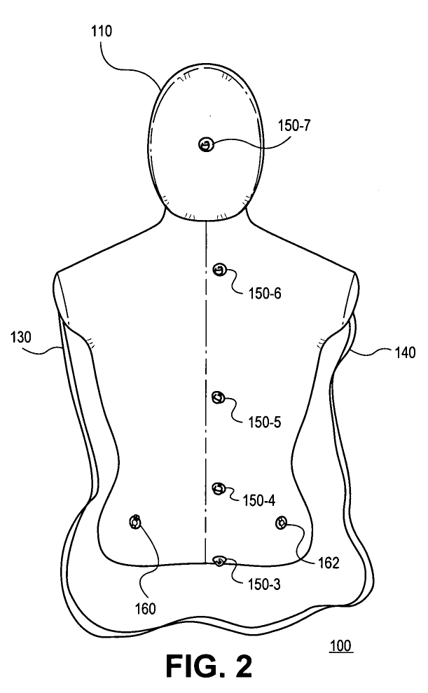

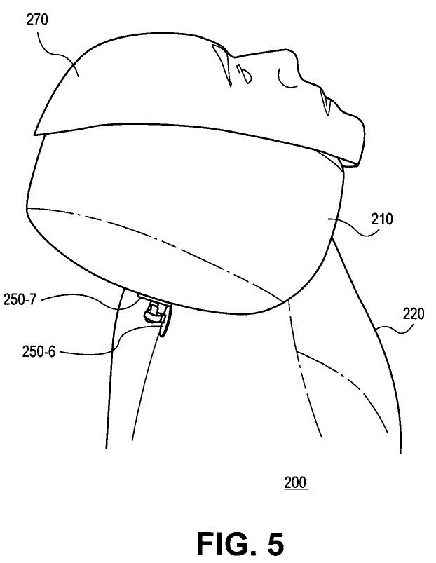

FIG. 2 further illustrates a rear view of device 100 of FIG. 1 in accordance with one embodiment. Representatively, torso portion 120 includes a plurality of anchor members 250 (250-1, . . . , 250-7) affixed to a surface of the torso portion. In one embodiment, the plurality of anchor members 250 are coupled to a selected one or more of the plurality of anchor members to simulate different postures of a human figure, for example, as illustrated with reference to FIG. 5. Representative elements for anchor members 250 include, but are not limited to, eyelets or other like elements that may be temporarily secured to one another to facilitate deformation of torso portion 120 and/or head portion 110 to simulate the different postures.

Representatively, anchor members 150-3 through 150-6 are affixed to torso portion in a vertical direction, such as, for example, along an imaginary spine of device 100. In one embodiment, anchor member 150-7 is affixed to the surface of head portion along the vertical direction defined by anchor members 150-3 through 150-6. As further illustrated in FIG. 5, one or more anchor members may be secured to one another using, for example, a zip tie, an acrylic clip, a double-ended snap or other like element, for joining one or more of the selected anchor members 150. Accordingly, in one embodiment, securing of anchor members 150 enables simulation of upright or arched postures by device 110 when, for example, a removable mask (see FIGS. 4-7) is secured to head portion 110 distal from anchor member 150-7. Representative materials for use as the flexible material of torso portion 120 or head portion 110 include polyvinyl chloride (PVC) or other like pliable material, which may be shaped to define torso or head portions to simulate the human figure, in accordance with one embodiment. In one embodiment, the PVC has a thickness between 0.12 mm and 0.75 mm. In one embodiment, the PVC is in the range of 0.19 mm and 0.2 mm thick.

As further illustrated in FIG. 2, torso portion includes rapid inflate/deflate valve 160 and safety valve 162. In one embodiment, rapid inflate/deflate valve is sized to couple to, for example, a hose to quickly fill torso and/or head portions with a fluid, such as air. In one embodiment, safety valve 162 has reduced size to limit expulsion of air from torso and/or head portions. In one embodiment, safety valve 160-2 is used to slowly deflate torso and/or head portions to enable coupling of anchor members 150-3 through 150-7 to simulate different postures of the human figure. In other words, to alter or deform device 100 into a desired posture, safety valve 162 is used to increase the pliability of torso portion by reducing air pressure within device 100. In the event that too much air is released, reinflation to a desired level may be performed through the safety valve 162.

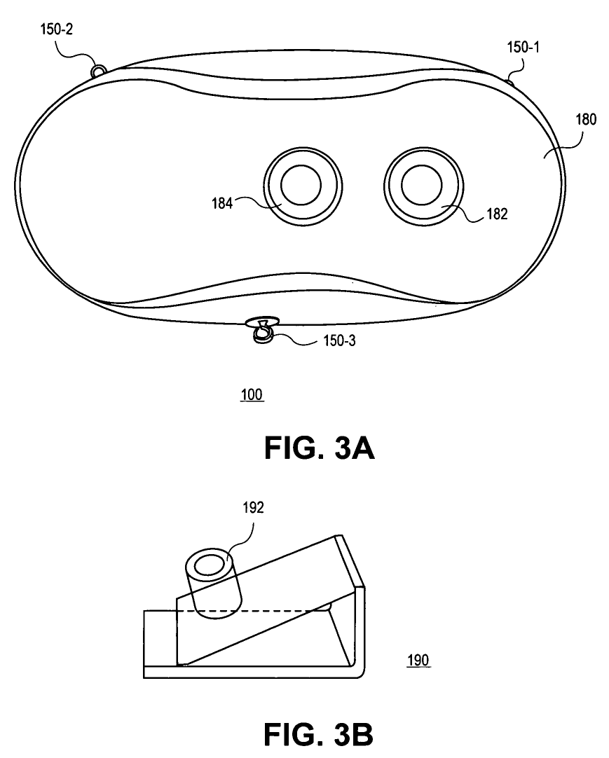

FIG. 3A is a block diagram illustrating a weighted base portion 180 of device 100, in accordance with one embodiment. In one embodiment, weighted base portion 180 is coupled to torso portion 120 distal from head portion 110 to maintain device 100 in an upright position by providing a gravitational low point of device 100 in an upright position.

Representatively, base portion 180 includes first mounting receptacle 182 and second mounting receptacle 184. Although illustrated to include first and second mounting receptacles 182 and 184, those skilled in the art will recognize that base portion may include any number of mounting receptacles while falling within the scope of a device for simulation of a human figure, in accordance with one or more above-described embodiments. In an alternate embodiment, base portion 180 does not include mounting receptacles 182 and 184 and is simply weighted to provide a gravitational low point of device 100 in an upright position. In one embodiment, base portion 180 comprises at least one mounting receptacle to mate with a mounting pin to secure device 100 in a desired position. In one embodiment, base portion 180 is formed from a number of layers of cardboard, e.g., three, four or five, and plastic sleeves to define the mounting receptacles 182, 184.

In one embodiment, anchor members 150-1, 150-2 and 150-3 are used to further secure device 100 according to a desired position. In one embodiment, clip 190 including at least one mounting pin 192 is secured to a seat to mate with a mounting receptacle of weighted base portion 180, as shown in FIG. 3B. Representative materials for use as chip 190 include acrylic, thermoplastic or other semi-rigid material to enable securing clip 190 to a seat. Clip 190 may be used to secure device 100 to various seating types, such as bleachers or bench seats, in addition to conventional theatre style seating (i.e., where seat backs are armrests are present). In one embodiment, a mounting plate, including at least one mounting pin, is used to secure device 100 to, for example, a flat area, such as a grassy area that does not contain seats. Mounting plate may be a dish of suitable size to achieve stability based on the locale.

FIG. 4 is a block diagram illustrating a right-side view of device 200 for simulation of a human figure, in accordance with one embodiment. Representatively, removable mask 270 is secured to head portion 210 of device 200. Representatively, removable mask 270 is provided to further simulate a face of a human figure. In one embodiment, mask 270 is formed from a flexible material, such as, for example, a clear plastic, and painted to simulate the features of a human face, including complexion, eye color, facial hair, expression or the like. In one embodiment, removable mask 270 enables seamless transition of human figure simulation, including gender alteration, ethnicity alteration and other like alteration to simulate a human figure, for example, within a crowd scene of a television show, motion picture or print advertisement. Additionally, the mask may be placed on the head portion in substantially an arbitrary orientation. This permits a more natural crowd by permitting the gaze direction of the mask to vary as desired rather than always looking straight forward. For example, the mask may be rotated 30° to the right to simulate a crowd member looking to the right.

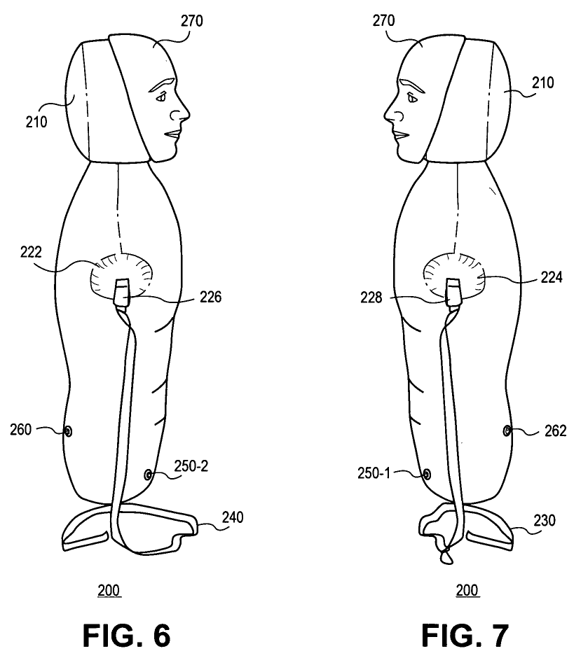

FIG. 5 is a block diagram further illustrating device 200 of FIG. 6, in accordance with one embodiment. Representatively, anchor member 250-6 of torso portion 220 and anchor member 250-7 of head portion 210 are adjoined to simulate posture of a human figure using, for example, a clip (or a zip tie). By changing the tightness of the zip tie, the appearance of different amounts of upward size may be created. Representatively, device 200 is shown simulating a human figure staring in an upward direction. Accordingly, using the various anchor members 250 attached to a surface of torso portion 220 and/or head portion 210, for example, as illustrated in FIG. 2, various postures of a human figure may be simulated to provide, for example, a life-like crowd scene for motion picture, television program or print advertisement.

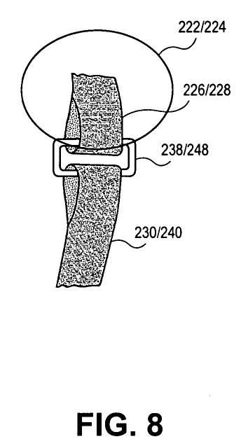

FIG. 6 is a block diagram illustrating a right-side view of device 200, in accordance with one embodiment. Representatively, torso portion 220 of device 200 is shown including shoulder portion 222. Representatively, in one embodiment, shoulder portion 222 includes attachment sleeve 248 to secure strap 240 to shoulder portion 222 of device 200. A suitable form of attachment sleeves 248 is a plastic sleeve or other panel of flexible material (e.g., polyvinyl chloride) to secure to shoulder portion 222 to provide an opening to secure clamp 238/248. In one embodiment, a proximate portion of strap 230/240 is sewn over clamp 238/248 distal from attachment sleeve 226/228, as shown in FIG. 8.

FIG. 7 illustrates a left-side view of device 200, in accordance with one embodiment. Representatively, torso portion 220 includes opposed shoulder portion 224, which also includes attachment sleeve 232 to secure a proximate portion of strap 230 to torso portion 220 of device 200. In one embodiment, straps 230 and 240 may be used to secure device 200 to a seat, the ground or other seating area to stabilize the device and possibly maintain the device in a desired position, such as an upright position. Representatively, proximal portions of straps 230 and 240 are attached to shoulder portions 220 and 224, respectively, of torso 220.

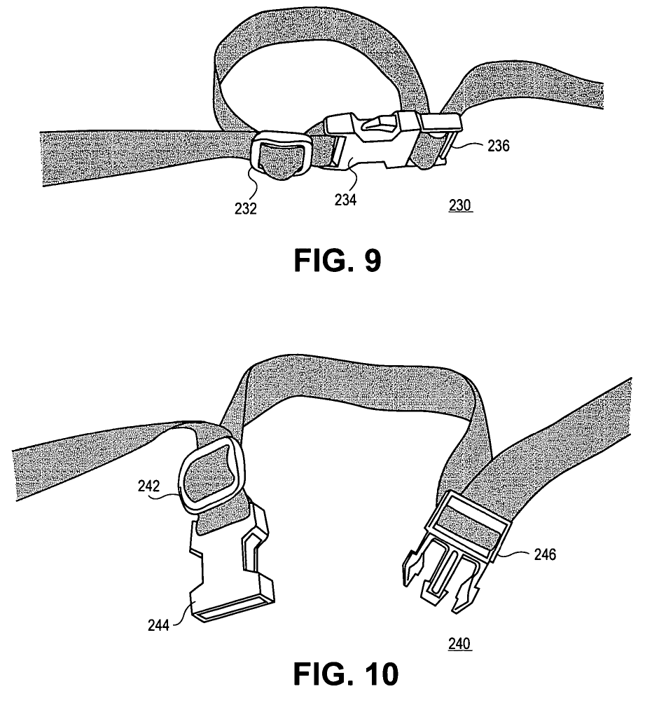

In one embodiment, distal portions of straps 230 and 240, to secure the device or stabilize device 200 in a desired position, are further illustrated with reference to FIGS. 9 and 10. FIG. 9 is a block diagram further illustrating a distal portion of strap 230, in accordance with one embodiment. Representatively, a length of strap 230 is adjustable via adjustment member 232 to either lengthen or shorten strap 230, depending on desired stabilization of device 200. As further illustrated, attachment members 234 and 236 interlock with one another to secure distal portion of strap 230 to, for example, an armrest of a seat.

FIG. 10 is a block diagram illustrating a distal portion of strap 240 of FIG. 6, in accordance with one embodiment. Representatively, strap 240 includes length adjustment member 242. Further illustrated attachment members 244 and 246 interlock with one another to secure distal portion of strap 240 to, for example, a seat, such as, for example, an armrest of a seat. Representative materials for straps 230 and 240 include nylon mesh, plastic or other like material. In one embodiment, the straps are between ½″ and 1″ wide and between 35″ and 45″ long. Representative materials for members 232-236 and 242-26 include any semi-rigid material, such as plastic

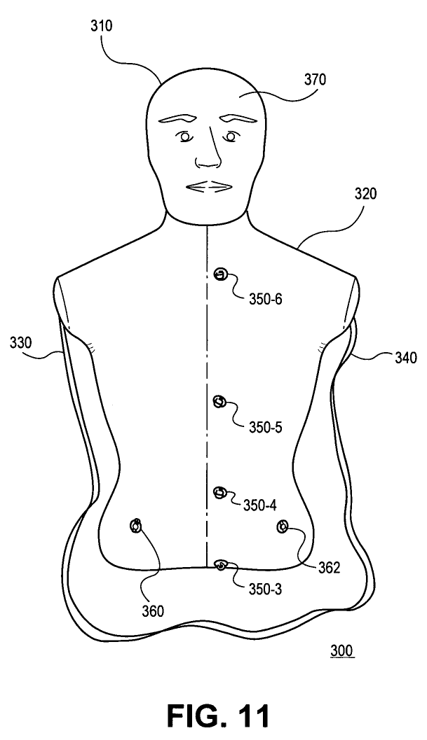

FIG. 11 is a block diagram further illustrating rear-side view of device 100 of FIG. 1 having removable mask 370 secured to head portion 310, in accordance with one embodiment. Representatively, removable mask 370 is coupled to head portion proximate anchor member 350-7 (not shown). In one embodiment, positioning of anchor members 350-3 through 350-6 along a vertical line following, for example, an imaginary spine of torso portion 320 enables deformation of torso portion 320 when one or more of anchor members 350-3 through 350-6 are secured to one another using, for example, a clip or zip tie. Representatively, device 300 would simulate a relaxed position, such as a slouched position often exhibited by fans viewing a sporting event. In such an embodiment, shoulder portions of device 300 could be relaxed to further simulate a relaxed or slouched posture. As described with reference to FIG. 2, safety valve 362 could be used to slowly deflate torso portion 320 to enable coupling of one or more anchor members 350 to simulate different postures, such as the slouched posture.

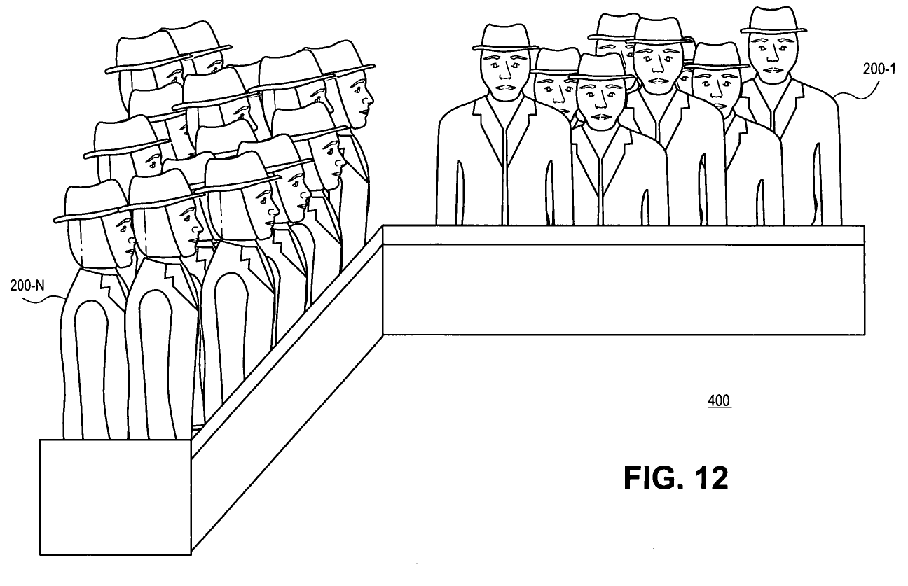

FIG. 12 is a block diagram illustrating crowd scene simulation using a plurality of devices for simulation of a human figure, for example, as illustrated with reference to FIGS. 4-9. Representatively, devices 200 (200-1, . . . , 200-N) may be arranged according to a desired configuration. Representatively, once closed, strap portions 230 and 240 (not shown) simulate arms of a human figure and aid in stabilizing a device 200 within, for example, an upright position, as shown in FIG. 12. In one embodiment, attachment members secured to torso or head portions of devices 200 may be affixed to one another to simulate posture, such as, an upright stare, a slouched posture or other like human posture. Representatively, such devices as described herein may be arranged, as illustrated in FIG. 12, including one or more extras to reduce the need for employing possibly thousands of extras to film a crowd scene within a television, motion picture or print advertisement.

Alternate Embodiments

Several aspects of one implementation of the device for simulating a human figure have been described. However, various implementations of the device provide numerous features including, complementing, supplementing, and/or replacing the features described above. In addition, the foregoing description, for purposes of explanation, used specific nomenclature to provide a thorough understanding of the invention. However, it will be apparent to one skilled in the art that the specific details are not required to practice the invention.

In addition, although an embodiment described herein is directed to a device for simulation of a human figure, it will be appreciated by those skilled in the art that the teaching of the present invention can be applied to other systems. In fact, the inclusion of extras (humans) along with the device to simulate a crowd scene are within the embodiments described, without departing from the scope and spirit of the present invention. The embodiments described above were chosen and described to best explain the principles of the invention and its practical applications. These embodiment were chosen to thereby enable others skilled in the art to best utilize the invention and various embodiments with various modifications as are suited to the particular use contemplated.

It is to be understood that even though numerous characteristics and advantages of various embodiments have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the present invention to the full extent indicated by the broad general meaning of the terms in which the appended claims are expressed.

Having disclosed various embodiments, modifications and variations may be made to the disclosed embodiments while remaining within the scope of the invention as defined by the following claims.

What is claimed is:

1. A device for simulation of a human figure comprising:
at least one panel of flexible material defining a first chamber that when filled with a fluid defines a torso portion of the device;
at least one panel of flexible material defining a second chamber that when filled with a fluid defines a head portion of the device, the head portion coupled to the torso portion; and
at least one anchor member coupled to the flexible material defining at least one of the first and second chambers to facilitate deformation of at least one of the torso portion and the head portion to simulate different postures.

2. The device of claim 1, wherein the first and second chambers are in fluid communication.

3. The device of claim 1, further comprising:
a first stabilization strap coupled to the torso portion; and
a second stabilization strap coupled to the torso portion.

4. The device of claim 1, wherein the first and second straps are respectively coupled to a right shoulder and a left shoulder of the torso portion.

5. The device of claim 1, wherein the anchor members comprise eyelets adhered to the flexible material.

6. The device of claim 1, wherein the flexible material is a polyvinyl chloride.

7. The device of claim 1, wherein at least one anchor member is affixed to the head portion and a plurality of anchor members are affixed to the torso portion.

8. The device of claim 1, further comprising:
a weighted base portion coupled to the torso portion distal from the head portion, the base portion adapted to maintain the device in an upright position.

9. The device of claim 1, further comprising:
a valve to provide fluid communication into at least one of the first chamber and second chamber to permit inflation of the device.

10. The device of claim 1, further comprising:
a removable mask to be disposed on the head portion to simulate a face of the human figure.

11. A device to simulate a human figure, comprising:
at least one panel of flexible material defining a first chamber that when filled with a fluid defines a torso portion of the device;
at least one panel of flexible material defining a second chamber that when filled with a fluid defines a head portion of the device, the head portion coupled to the torso portion;
a first strap having a proximate portion coupled to a shoulder portion of the torso portion and a distal portion to secure the device; and
a second strap having the proximate portion coupled to an opposed shoulder portion of the torso portion and a distal portion to secure the device.

12. The device of claim 11, further comprising:
a weighted base portion coupled to the torso portion distal from the head portion to maintain the device in an upright position.

13. The device of claim 11, wherein a plurality of anchor members are affixed to the torso portion, the plurality of anchor members to couple to a selected one or more of the plurality of anchor members to further define the exterior spin of the device to simulate different postures.

14. The device of claim 11, wherein at least one anchor member is affixed to a surface of the head portion to couple to at least one anchor member affixed to the torso portion to simulate different postures.

15. The device of claim 14, further comprising
removable mask secured to the head portion proximate the anchor member affixed to the head portion to simulate a relaxed posture.

16. The device of claim 15, further comprising:
a removable mask is secured to the head portion distal from the anchor member to simulate an upright posture.

17. The device of claim 11, wherein the distal portion of the first and second straps comprises:
an adjustable fastener to secure the device to a seat.

18. The device of claim 11, wherein a length of the first and second straps is adjustable.

19. The device of claim 11, further comprising:
a valve to provide fluid communication into at least one of the first chamber and second chamber to permit inflation of the device.

20. The device of claim 19, wherein the valve further comprises:
a rapid inflate/deflate valve; and
a safety inflate/deflate valve to enable pressure adjustment of the device.

21. The device of claim 11, wherein the anchor members comprise eyelets adhered to the flexible material.

22. The device of claim 21, wherein the flexible material is a polyvinyl chloride.

23. The device of claim 17, wherein the adjustable fasteners secure the first and second straps to armrests of the seat.

24. The device of claim 12, further comprising:
at least one clip including a mounting pin to mate with a mounting receptacle of the weighted base portion when the clip is secured to a seat.

25. A method to simulate a crowd scene, comprising:
(a) selecting a device to simulate a human figure;
(b) securing first and second straps coupled to opposed shoulder portions of a torso of the selected device;
(c) attaching a replaceable mask to a head portion of the selected device to simulate a face of the human figure; and
(d) repeating (a)-(c) for a predetermined number of selected devices to simulate the crowd scene.

26. The method of claim 25, wherein attaching comprises:
facing the mask in a direction on the head portion to achieve a desired gaze direction.

27. The method of claim 25, wherein selecting the device, further comprises:
deflating the device to enable securing of one or more anchors attached to a surface of the device to simulate a posture of the human figure.

28. The method of claim 25, wherein selecting the device further comprises:
adhering a clip including a mounting pin to a seat; and
mating the pin attached to the seat to at least one mounting receptacle within a base portion of the selected device to secure the device in a desired position.

29. The method of claim 25, further comprising:
clothing each device within the crowd scene, such that once clothed, the straps used to secure each device to armrests of the seat simulate arms of a human figure.

30. The method of claim 25, further comprising:
placing one or more actors among the selected device to further simulate the crowd scene.
